(19) United States
(12) Patent Application Publication
(10) Pub. No.: US 2006/0046676 A1
(43) Pub. Date: Mar. 2, 2006

(54) Method for evaluating the redeption quality of a stereo radio set and stereo radio set

(76) Inventors: Christoph Benz, Ohlsbach (DE); Stefan Gierl, Karlsruhe (DE)

Correspondence Address: THE ECLIPSE GROUP, 10605 BALBOA BLVD., SUITE 300, GRANADA HILLS, CA, 91344, US

(21) Appl. No.: 10/519,773

(22) PCT Filed: Jun. 26, 2003
(86) PCT No.: PCT/EP03/06793

§ 371 Date: Jul. 8, 2005

(30) Foreign Application Priority Data
Jun. 27, 2002 (DE) 10228723.6

(51) Int. Cl. H04B 17/00

(52) U.S. Cl. 455/226.1; 455/67.13

(57) ABSTRACT

According to the invention, a precise criterion for evaluating the reception quality is derived in a stereo radio set from the signal energy or power of the upper and lower sideband (OS, US) of the L−R signal (L−R) of the stereo multiplex signal (MPX). To achieve this, the upper sideband (OS) is filtered out of the L−R signal (L−R) using a first bandpass filter (BP1) and is mixed with an auxiliary carrier (H) of 38 KHz in a first mixer (M1) and shifted to the baseband. Similarly, the lower sideband (US) is filtered out of the L−R signal (L−R) using a second bandpass filter (BP2) and is mixed in a second mixer (M2) with an auxiliary carrier (H) of KHz and shifted to the baseband. The output signal of the first mixer (M1) is filtered in a first lowpass filter (TP1), whilst the output signal of the second mixer (M2) is filtered in a second lowpass filter (TP2). The cross-correlation (Q), which represents an extremely precise measurement of reception quality, is formed in a unit (K) from the output signals of the two lowpass filters (TP1, TP2). The greater the cross-correlation, the higher the reception quality.

A method of evaluating the quality of reception of a stereo radio receiver, and a stereo radio receiver.

The invention relates to a method of evaluating the reception quality in a stereo radio receiver comprising a receiver for generating the stereo multiplex signal from which a decoder generates the (L+R) signal and, via an auxiliary carrier, generates the top and the bottom side-band of the (L−R) signal.

The invention also relates to a stereo radio receiver comprising a receiver for generating the stereo multiplex signal and a decoder for generating the (L+R) signal and the top and bottom side-band of the (L−R) signal from the stereo multiplex signal via an auxiliary carrier.

High-quality stereo radio receivers for motor vehicles are suitable for multipath reception, e.g. for antenna or frequency diversity or a combination of the two.

“Multipath reception” means reception of radio signals on one out of a number of transmission paths or channels.

Known multipath reception is via one out of a number of alternative antennas (known as antenna diversity) and on one or more alternative reception frequencies (known as frequency diversity).

An antenna-diversity receiving system is a radio receiving system comprising a radio receiver connectable to one out of a number of usually spatially separate antennas. Antenna-diversity receiving systems of this kind are used e.g. in motor vehicles. The antennas are preferably disc-type antennas incorporated e.g. in the vehicle windows. During operation of an antenna-diversity receiving system, e.g. a stereo radio receiver, a TV receiving system or a telephone system, a selection circuit selects one of the antennas for connection to the radio receiver in accordance with presettable criteria.

The criterion for evaluating the reception quality can e.g. be the reception field strength or disturbing interference occurring at higher reception field strength, e.g. as a result of interfering multipath reception due to signal reflections from mountains, buildings or similar radio wave-reflecting media.

If the reception quality declines, a switch is made to an alternative antenna which delivers reception signals of better quality.

A frequency-diversity reception system is a frequency reception system comprising an antenna and at least two radio receivers. One receiver is an operating receiver whereas the other receiver is a search and test receiver which searches for alternative reception frequencies and tests their quality. If the search receiver finds an alternative reception frequency of better quality than the reception frequency set at that moment by the operating receiver, either the operating receiver is tuned to the newly-found reception frequency or the search and operating receivers reverse roles. The search receiver then remains tuned to the just-found optimum reception frequency and takes over the function of the previous operating receiver, which now is the search receiver which searches for alternative reception frequencies and tests their quality. In car radios the operating receiver is also called the listening receiver, whereas the search receiver is usually called the background receiver.

Also, known car radios for frequency diversity need only one receiver. During operation the receiver, without being heard by the listener, checks reception of the just-set program on alternative frequencies. If an alternative frequency of better quality is found, the receiver is tuned to this reception frequency.

Frequency-diversity reception systems, like antenna-diversity reception signals, are particularly suitable for use in motor vehicles, because the reception conditions change during the journey owing to the constant variation in the terrain. A combination of antenna and frequency diversity is particularly advantageous.

VHF radio receivers transmit a “stereo multiplex signal”, made up of the centre audio signal (also called mono signal) at a frequency up to 15 KHz, the stereo pilot tone at a frequency of 15 KHz and the stereo signal at a frequency of 23 to 53 KHz.

The mono signal is the aggregate signal from the left and right channel and is therefore also called the (L+R) signal. The stereo signal comprises the bottom and top side-band of the difference signal from the left and the right channel. This signal is usually called (L−R). The top and the bottom side-band of the (L−R) signal are generated by an auxiliary carrier at 38 KHz.

In a stereo radio receiver the (L+R) signal is obtained from the received signal and the top and the bottom side-band of the (L−R) signal are obtained via a 38 KHz auxiliary carrier generated in the stereo radio receiver. The audio signal for the left channel (the L signal) and the audio signal for the right channel (the R signal) are obtained by forming the aggregate signal and the difference signal from the (L−R) signal and the (L+R) signal. The analog stereo multiplex signal is preferably digitised before further processing.

As already mentioned, in order to switch over to an alternative antenna or an alternative reception frequency, the reception quality has to be determined by means of a criterion. It is known to determine the reception quality by evaluating the reception field strength or disturbing interference. The IF signal or the HF signal for example can be evaluated for this purpose.

In order substantially always to select the best reception frequency or antenna at the moment in a reception system for multipath reception, the reception quality must be evaluated in accordance with strict standards.

The object of the invention therefore is to devise a method of evaluating the reception quality in a stereo radio receiver and to design a stereo radio receiver so as to obtain substantially accurate, reliable and rapid evaluation of the reception quality.

With regard to the process, this problem is solved by the features disclosed in claim 1, in that a criterion for evaluating the quality of reception is derived from the signal energy or the power of the top and bottom side-band of the (L−R) signal.

With regard to the device, the problem is solved by the features disclosed in claim 11, in that a signal for evaluating the reception quality is derived from the signal energy or power of the top and bottom side-band of the (L−R) signal.

According to the invention, a criterion for evaluating the reception quality is derived from the signal energy or power of the top and the bottom side-band of the (L−R) signal. The invention is based on the following discoveries and considerations:

When reception of a frequency-modulated stereo radio signal is undisturbed, the top and the bottom side-band of the (L−R) signal are identical relative to the 38 KHz auxiliary carrier. If however the frequency-modulated stereo radio signal is overlaid by interference, the spectral distribution of the interfering components after demodulation will mean that the bottom and the top side-band of the (L−R) signal are no longer identical but differ relative widely. According to the invention this effect is used in order to detect disturbances and thus to judge the quality of reception.

In a first exemplified embodiment of the invention, the signal energy or the power of the top side-band is compared with that of the bottom side-band. The greater the difference between the two compared signal energies or powers, the greater the interference and the lower the reception quality. Optimum reception quality is obtained when the signal energies or powers of the top and bottom side-band are identical.

According to another exemplified embodiment of the invention, the cross-correlation function is obtained between the signals or power of the bottom side-band and the signal energy or power of the top side-band. The higher the correlation, the better the reception quality, whereas a decrease in correlation is associated with a reduction in the reception quality. The cross-correlation is a very accurate measure of the quality of reception.

In another exemplified embodiment of the invention, the bottom side-band of the (L−R) signal is filtered by a first bandpass filter and the top side-band of the (L−R) signal is filtered by a second bandpass filter. A signal measuring the quality of reception is obtained by comparing the signal energies or powers at the outputs of the two bandpass filters or by obtaining the cross-correlation function of the two output signals from the two bandpass filters.

Preferably the two bandpass filters are dimensioned so that their pass bands do not overlap.

The centre frequency of the first bandpass filter is e.g. 31 KHz whereas the centre frequency of the second bandpass is 45 KHz.

The bandpass filters can e.g. be second-order Butterworth bandpass filters.

In another exemplified embodiment of the invention, the output signals of the two bandpass filters are shifted into the base band position by mixing with the 38 KHz auxiliary carrier in a respective mixer and are then filtered by a respective low-pass filter before the signal energies or the power are compared with one another or the cross-correlation function is obtained. Preferably the cross-correlation function of the output signal of the two low-pass filters is obtained, and is a strict measure of the quality of reception.

The invention will now be described and explained in further detail with reference to the drawings, in which:

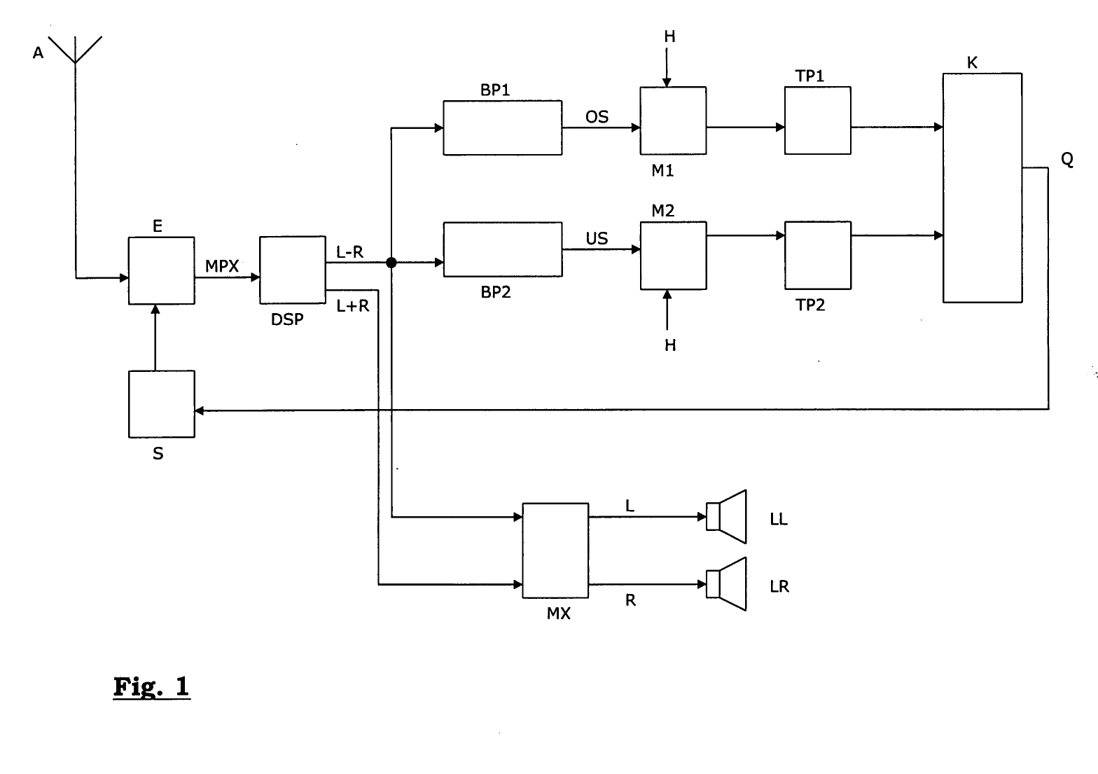

FIG. 1 is a block circuit diagram of an exemplified embodiment of a stereo radio receiver according to the invention and

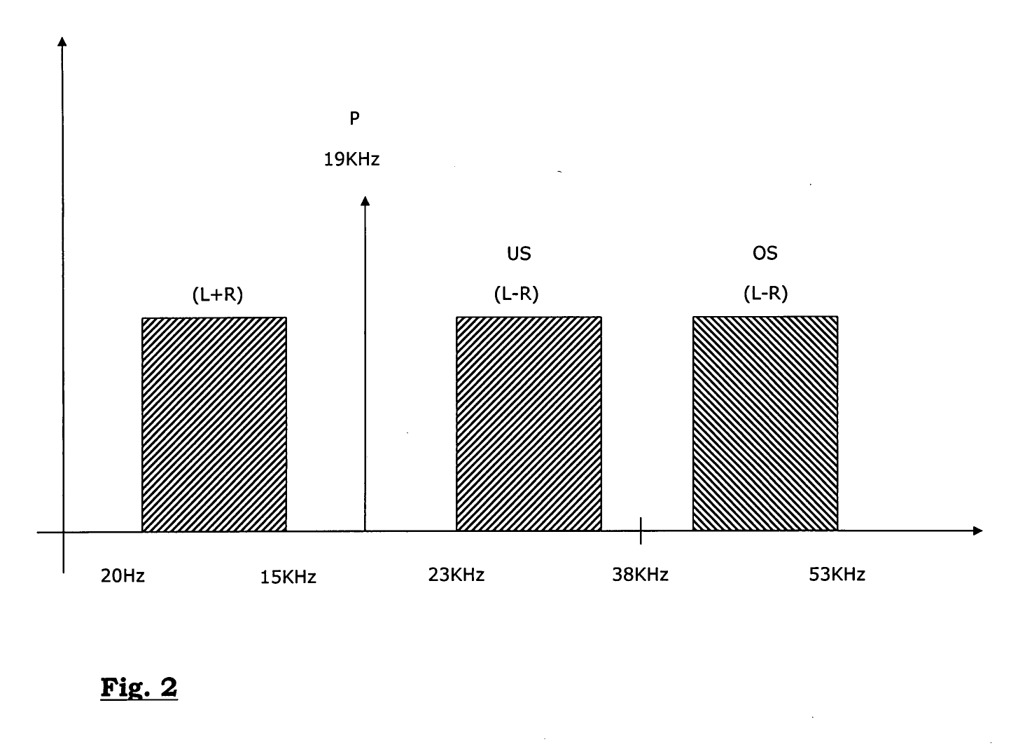

FIG. 2 shows the frequency spectrum of the stereo multiplex signal.

FIG. 1 is a block circuit diagram of an exemplified embodiment of a stereo radio receiver according to the invention.

An antenna A is connected to the antenna input of a receiver E whose output, from which the stereo multiplex signal MPS can be tapped, is connected to the input of a decoder DSP, preferably a digital signal processor. The first output of the digital signal processor DSP, from which the (L−R) signal can be tapped, is connected to the second input of a stereo matrix MX, the input of a first bandpass filter BP1 and the input of a second bandpass filter BP2. The second output of the digital signal processor DSP, from which the (L+R) signal can be tapped, is connected to the second input of the stereo matrix MX, whose first input, from which the L-signal L can be tapped, is connected to a first loudspeaker (the loudspeaker LL on the left) and whose second input, at which the R-signal R can be tapped, is connected to a second loudspeaker (the loudspeaker LR on the right). The output of the first bandpass filter is connected to the first input of a first mixer M1 whose second input receives the 38 KHz auxiliary carrier and whose output is connected to the input of a first low-pass filter TP1. Similarly the output of the second bandpass filter BP2 is connected to the first input of a second mixer M2 whose second input receives the 38 KHz auxiliary carrier H and whose output is connected to the input of a second low-pass filter TP2. The output of the first low-pass filter TP1 is connected to the first input and the output of the second low-pass filter TP2 is connected to the second input of a unit K for obtaining the cross-correlation function. A cross-correlation signal Q can be tapped from its output and is a measure for the reception quality. The cross-correlation signal Q is fed e.g. to a control input S which tunes the receiver E to the best reception frequency or, in the case of an antenna-diversity reception system, connects the antenna having the best reception to the receiver E. Alternatively the system can be a combined antenna-diversity and frequency-diversity reception system with a number of antennas and receivers, though omitted for clarity in FIG. 1.

The inventive part of the stereo radio receiver shown in FIG. 1 comprises the two bandpass filters BP1 and BP2, the two mixers M1 and M2, the two low-pass filters TP1 and TP2 and the unit K for obtaining the cross-correlation function and is surrounded by a chain line in FIG. 1.

The purpose of the invention will now be explained with reference to the frequency spectrum of the stereo multiplex signal shown in FIG. 2.

The (L+R) signal, also called the mono or aggregate signal, extends from 20 Hz to 15 KHz. The pilot tone P is at 19 KHz and adjoins the bottom side-band of the (L−R) signal from 23 to 38 KHz. On the other side of the auxiliary carrier frequency of 38 KHz the top side-band of the (L−R) signal extends up to 53 KHz.

The digital (L−R) signal generated by the digital signal processor DSP from the analog stereo multiplex signal MPX is filtered in a first bandpass filter BP1 with a centre frequency of 31 KHz and fed to a mixer M1 where it is mixed with the 38 KHz auxiliary carrier and shifted into the basic band position. Similarly the digital (L−R) signal is filtered by the second bandpass filter BP2 with a centre frequency of 45 KHz and shifted into the basic band position by mixing with the 38 KHz auxiliary carrier in a mixer M2. The output signal of the mixer M1 shifted to the basic band position is filtered through the low-pass filter TP1. Similarly the output signal of the mixer M2 shifted into the basic band position is filtered in the low-pass filter TP2. The output signals of the two low-pass filters TP1 and TP2 are correlated in the unit K. A signal Q representing the cross-correlation therefore appears at the output of the unit K and is a very precise measure of the reception quality. The higher the correlation, the better the reception quality.

The invention however is not restricted to a digital exemplified embodiment. It can also be embodied in analog technology.

The method and the stereo radio receiver according to the invention are characterised by very accurate evaluation of the reception quality, which can be used for accurate switching over to an alternative antenna or an alternative reception frequency in an antenna-diversity or frequency-diversity reception system. The invention is particularly suitable for use in mobile stereo radio receivers, e.g. in motor vehicles.

List of reference symbols

A Antenna
BP1 Bandpass filter
BP2 Bandpass filter
DSP Decoder, digital signal processor
E Receiver
ER Inventive part
H 38 KHz auxiliary carrier
K Unit for obtaining the cross-correlation
L L-signal
LL Left loudspeaker
LR Right loudspeaker
L+R (L+R) signal
L−R (L−R) signal
MPX Analog stereo multiplex signal
MX Stereo matrix
M1 Mixer
M2 Mixer
P Pilot tone
Q Cross-correlation signal
R R-signal
S Control unit
TP1 Low-pass filter
TP2 Low-pass filter

1-26. (canceled)

27. A method of evaluating the reception quality in a stereo radio receiver comprising a receiver for generating the stereo multiplex signal from which a decoder generates the signal and, via an auxiliary carrier, generates the top and the bottom side-band of the signal, where a criterion for evaluating the quality of reception is derived from the signal energy or power of the top and bottom side-band of the signal.

28. A method according to claim 27, where the criterion for evaluating the reception quality is derived from a comparison between the signal energy or power of the top side-band with that of the bottom side-band of the signal and where the reception quality decreases when the difference between the two signal energies or powers increases, increases when the difference decreases, and is at a maximum when they are the same.

29. A method according to claim 27, where the criterion for evaluating the reception quality is derived from cross-correlation of the signals or of the power of the top and the bottom side-band of the signal and where the reception quality increases with increasing correlation and decreases with decreasing correlation.

30. A method according to claim 27, where the bottom side-band is filtered by a first bandpass filter and the top side-band is filtered by a second bandpass filter.

31. A method according to claim 30, where the centre frequency of the first bandpass filter is 31 KHz and that of the second bandpass filter is 45 KHz.

32. A method according to claim 30, where the pass bands of the two bandpass filters do not overlap.

33. A method according to claim 30, where the two bandpass filters are second-order Butterworth bandpass filters.

34. A method according to any of claims 30, where the output signal of the first bandpass filter is shifted into the base band position by mixing with the 38 KHz auxiliary carrier in a first mixer and then filtered in a first low-pass filter and the output signal from the second bandpass filter is shifted into the base band position by mixing with the 38 KHz auxiliary carrier and then filtered in a second low-pass filter.

35. A method according to claim 34, where the energy or power of the output signal from the first low-pass filter is compared with that of the second low-pass filter and the criterion for the quality of reception is derived from a comparison between the two energies or powers and where the reception quality decreases when the difference between the two energies or powers increases, increases when the difference decreases and is at a maximum when they are the same.

36. A method according to claim 34, where the cross-correlation is obtained from the output signal of the first low-pass filter and the output signal of the second low-pass filter and where the reception quality increases with increasing correlation and decreases with decreasing correlation.

37. A stereo radio receiver comprising a receiver for generating the stereo multiplex signal and a decoder for generating the signal and the top and bottom side-band of the signal from the stereo multiplex signal via an auxiliary carrier, where a criterion for evaluating the quality of reception is derived from the signal energy or power of the top and bottom side-band of the signal.

38. A stereo radio receiver according to claim 37, where the criterion for evaluating the reception quality is derived from a comparison between the signal energy or power of the top side-band with that of the bottom side-band of the signal and where the reception quality decreases when the difference between the two signal energies or powers increases, increases when the difference decreases, and is at a maximum when they are the same.

39. A stereo radio receiver according to claim 37, where the criterion for evaluating the reception quality is derived from cross-correlation of the signals or of the power of the top and the bottom side-band of the signal and where the reception quality increases with increasing correlation and decreases with decreasing correlation.

40. A stereo radio receiver according to claim 38, where a first bandpass filter is provided for filtering the bottom side-band and a second bandpass filter is provided for filtering the top side-band of the signal.

41. A stereo radio receiver according to claim 40, where the centre frequency of the first bandpass filter is 31 KHz and that of the second bandpass filter is 45 KHz.

42. A stereo radio receiver according to claim 40, where the pass bands of the two bandpass filters do not overlap.

43. A stereo radio receiver according to claim 40, where the two bandpass filters are second-order Butterworth bandpass filters.

44. A stereo radio receiver according to any of claims 40, where the output of the first bandpass filter is shifted into the base band position by mixing with the 38 KHz auxiliary carrier in a first mixer and then filtered in a first low-pass filter and the output signal from the second bandpass filter is shifted into the base band position by mixing with the 38 KHz auxiliary carrier and then filtered in a second low-pass filter.

45. A stereo radio receiver according to claim 44, where in that the energy or power of the output signal from the first low-pass filter is compared with that of the second low-pass filter and the criterion for the quality of reception is derived from a comparison between the two energies or powers, and where the reception quality decreases when the difference between the two energies or powers increases, increases when the difference decreases and is at a maximum when they are the same.

46. A stereo radio receiver according to claim 44, where the cross-correlation is obtained from the output signal of the first low-pass filter and the output signal of the second low-pass filter and where the reception quality increases with increasing correlation and decreases with decreasing correlation.

47. A stereo radio receiver according to claim 46, where the signal is received at the input of the first bandpass filter and the second bandpass filter, the output of the first bandpass filter is connected to the first input of the first mixer whose second input receives the auxiliary carrier, the output of the second bandpass filter is connected to the first input of the second mixer, whose second input receives the auxiliary carrier, the output of the first mixer is connected to the input of a first low-pass filter, whose output is connected to the first input of a unit for generating the cross-correlation, the output of the second mixer is connected to the input of a second low-pass filter whose output is connected to the second input of the unit for obtaining the cross-correlation, and a quality signal for measuring the quality of reception can be tapped from the output of the unit for obtaining the cross-correlation.

48. A stereo radio receiver according to claim 47, where the output of the unit for obtaining the cross-correlation is connected to the input of a control unit whose output is connected to the control input of the receiver or of an antenna selection switch.

49. A stereo radio receiver according to claim 47, where the bandpass filters are second-order Butterworth bandpass filters.

50. A stereo radio receiver according to claim 47, where the pass bands of the two bandpass filters do not overlap.

51. A stereo radio receiver according to any of claims 47, where the centre frequency of the first bandpass filter is 31 KHz and the centre frequency of the second bandpass filter is 45 KHz.

52. A stereo radio receiver according to any of claims 47, where the auxiliary carrier has a frequency of 38 KHz.
